(19) United States
(12) Patent Application Publication
(10) Pub. No.: US 2025/0166552 A1
(43) Pub. Date: May 22, 2025

(54) DISPLAY DEVICE AND METHOD FOR DRIVING THE SAME

(71) Applicant: Samsung Display Co., LTD., Yongin-si (KR)

(72) Inventors: Hyun Ho LIM, Yongin-si (KR); Yoo Sung KIM, Yongin-si (KR)

(21) Appl. No.: 18/810,924

(22) Filed: Aug. 21, 2024

(30) Foreign Application Priority Data
Nov. 21, 2023 (KR) 10-2023-0162567

(51) Int. Cl. G09G 3/20; G09G 3/3225; G09G 3/3275

(52) U.S. Cl. CPC G09G 3/2096; G09G 3/3225; G09G 3/3275; G09G 2310/0297; G09G 2320/02; G09G 2330/12; G09G 2354/00; G09G 2370/08

(57) ABSTRACT

A display device includes a display panel; a timing controller configured to output image data; a data driver configured to receive the image data from the timing controller, to divide the received image data into first image data and second image data, and to alternately output the first image data and the second image data; and a switching circuit configured to receive the first image data and the second image data from the data driver, to supply the first image data to sub-pixels of a first group in the display panel, and to supply the second image data to sub-pixels of a second group in the display panel, wherein the timing controller is configured to: identify that a lock fail of a clock signal has occurred in the data driver upon receiving a first control signal from the data driver.

### CROSS-REFERENCE TO RELATED APPLICATION

The present application claims priority to and the benefit of Korean Patent Application No. 10-2023-0162567, filed on Nov. 21, 2023, in the Korean Intellectual Property Office, the entire disclosure of which is incorporated herein by reference.

### BACKGROUND

### 1. Field of the Disclosure

Aspects of the present disclosure relate to a display device and a method for driving the same.

### 2. Description of the Related Art

As the information-oriented society evolves, the demand for display devices is ever increasing. For example, display devices are being employed by a variety of electronic devices such as smart phones, digital cameras, laptop computers, navigation devices, and smart televisions.

The resolution of display panels of display devices becomes higher and higher. Accordingly, the number of data drivers (e.g., source driver circuits) increases, and thus fabrication costs increase. Accordingly, an approach has been proposed to reduce the number of data drivers by employing a switching unit that works as a demultiplexer in the display panel. To do so, it is desirable for the data driver to distinguish the image data input from the timing controller to match the switching unit that works as a demultiplexer. If the data driver fails to accurately distinguish the type of image data input from the timing controller, display defects may occur.

The above information disclosed in this Background section is only for enhancement of understanding of the background of the invention and therefore it may contain information that does not form the prior art.

### SUMMARY

Aspects of some embodiments of the present disclosure are directed to a display device that can prevent or substantially reduce display defects by allowing fewer data drivers to accurately distinguish the type of image data input from a timing controller.

According to some embodiments of the present disclosure, there is provided a display device including: a display panel; a timing controller configured to output image data; a data driver configured to receive the image data from the timing controller, to divide the received image data into first image data and second image data, and to alternately output the first image data and the second image data; and a switching circuit configured to receive the first image data and the second image data from the data driver, to supply the first image data to sub-pixels of a first group in the display panel, and to supply the second image data to sub-pixels of a second group in the display panel, wherein the timing controller is configured to: identify that a lock fail of a clock signal has occurred in the data driver upon receiving a first control signal from the data driver while transmitting the image data for one frame; and upon identifying the lock fail, to interrupt transmission of the image data and to transmit a clock training signal to the data driver to lock the clock signal, and to resume transmission of the image data when lock of the clock signal is completed, and to transmit to the data driver an identification signal for identifying a transmission time point of the first image data.

In some embodiments, the sub-pixels of the first group are odd sub-pixels of a plurality of sub-pixels in the display panel that are arranged in odd columns, and the sub-pixels of the second group are even sub-pixels of the plurality of sub-pixels that are arranged in even columns.

In some embodiments, the timing controller is configured to output the first image data when resuming transmission of the image data.

In some embodiments, the timing controller, upon receiving the first control signal, is configured to transmit a second control signal for controlling training of the data driver and the clock training signal to the data driver.

In some embodiments, the timing controller is configured to transmit a frame protocol to the data driver before outputting the first image data when resuming transmission of the image data, and the frame protocol is a setup signal.

In some embodiments, the data driver is configured to divide the received image data into the first image data and the second image data based on the identification signal when the timing controller resumes transmission of the image data, and to output the first image data and the second image data alternately.

In some embodiments, the switching circuit is configured to receive the first image data and the second image data from the data driver, and the switching circuit includes a first switching circuit is configured to supply the first image data to the odd sub-pixels in response to a first switching signal output from the timing controller, and a second switching circuit is configured to supply the second image data to the even sub-pixels in response to a second switching signal output from the timing controller.

In some embodiments, the switching circuit is in a non-display area of the display panel.

In some embodiments, switching circuit includes a thin-film transistor.

In some embodiments, the timing controller is configured to synchronize a time point of outputting the first switching signal with a time point of outputting the identification signal when resuming transmission of the image data.

In some embodiments, the switching circuit is in the data driver.

In some embodiments, the timing controller is configured to synchronize a time point of outputting the first switching signal with a time point of outputting the identification signal when resuming transmission of the image data.

According to some embodiments of the present disclosure, there is provided a method for driving a display device, the method including: outputting, by a timing controller, image data; receiving, by a data driver, the image data from the timing controller to divide the received image data into first image data and second image data; alternately outputting, by the data driver, the first image data and the second image data; receiving, by a switching circuit, the first image data and the second image data from the data driver, to supply the first image data to sub-pixels of a first group in a display panel, and to supply the second image data to sub-pixels of a second group in the panel; identifying, by the timing controller, that a lock fail of a clock signal has occurred in the data driver upon receiving a first control signal from the data driver while transmitting the image data for one frame; upon identifying the lock fail by the timing controller, interrupting transmission of the image data and transmitting a clock training signal to the data driver to lock the clock signal; and resuming, by the timing controller, transmission of the image data when lock of the clock signal is completed, and transmitting to the data driver an identification signal for identifying a transmission time point of the first image data.

In some embodiments, the sub-pixels of the first group are odd sub-pixels of a plurality of sub-pixels that are arranged in odd columns in the display panel, and the sub-pixels of the second group are even sub-pixels of the plurality of sub-pixels that are arranged in even columns.

In some embodiments, the method further includes: outputting, by the timing controller, the first image data when resuming transmission of the image data.

In some embodiments, the method further includes: upon receiving the first control signal, transmitting, by the timing controller, a second control signal for controlling training of the data driver and the clock training signal to the data driver.

In some embodiments, the method further includes: transmitting, by the timing controller, a frame protocol to the data driver before outputting the first image data when resuming transmission of the image data, wherein the frame protocol is a setup signal.

In some embodiments, the method further includes: dividing, by the data driver, the received image data into the first image data and the second image data based on the identification signal when the timing controller resumes the transmission of the image data.

In some embodiments, the method further includes: supplying, by a first switching circuit of the switching circuit, the first image data to the odd sub-pixels in response to a first switching signal output from the timing controller; and supplying, by a second switching circuit of the switching circuit, the second image data to the even sub-pixels in response to a second switching signal output from the timing controller.

In some embodiments, the method further includes: synchronizing, by the timing controller, a time point of outputting the first switching signal with a time point of outputting the identification signal when resuming transmission of the image data.

Thus, according to some embodiments of the present disclosure, it is possible to reduce the number of data drivers in a display device.

In addition, it is possible to prevent or substantially reduce display defects by allowing the data drivers to accurately distinguish the type of image data input from the timing controller.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an exploded, perspective view of a display device according to some embodiments of the present disclosure.

FIG. 2 is a bottom view showing an example of a display panel when the flexible films of FIG. 1 are unfolded, according to some embodiments of the present disclosure.

FIG. 3 is a bottom view showing an example of the display panel when the flexible films of FIG. 1 are folded, according to some embodiments of the present disclosure.

FIG. 4 is a block diagram of a display device according to some embodiments of the present disclosure.

FIG. 5 is a cross-sectional view showing an example of a first substrate, a second substrate and a pixel array layer of a display panel, according to some embodiments of the present disclosure.

FIG. 6 is a diagram for conceptually illustrating output terminals of a data driver and a switching unit according to some embodiments of the present disclosure.

FIG. 7 is a diagram for illustrating connection relationships between a switching unit and a plurality of sub-pixels according to some embodiments of the present disclosure.

FIG. 8 is a diagram for conceptually illustrating a case in which a lock failure occurs in a data driver of a display device according to a comparative example.

FIG. 9 is a diagram for conceptually illustrating a case in which a lock failure occurs in a data driver of a display device according to some embodiments of the present disclosure.

FIG. 10 is a timing diagram for illustrating output signals from the timing controller and the data driver when a lock fail occurs in the data driver of the display device according to some embodiments of the present disclosure.

FIG. 11 is a signal diagram illustrating the operation of a display device according to some exemplary embodiments of the present disclosure.

FIG. 12 is a diagram illustrating an example in which a timing controller according to some embodiments does not output a frame protocol after performing lock recovery.

FIG. 13 is a signal diagram illustrating the operation of a display device according to some exemplary embodiments of the present disclosure.

### DETAILED DESCRIPTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

Features of each of various embodiments of the present disclosure may be partially or entirely combined with each other and may technically variously interwork with each other, and respective embodiments may be implemented independently of each other or may be implemented together in association with each other.

Hereinafter, specific embodiments will be described with reference to the accompanying drawings.

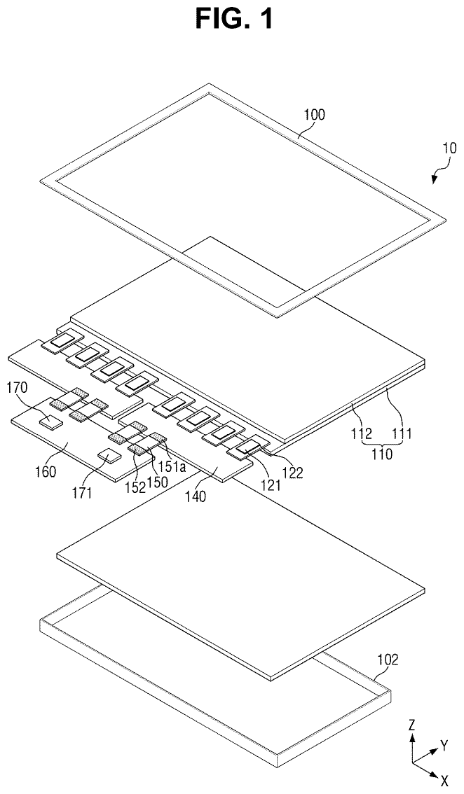

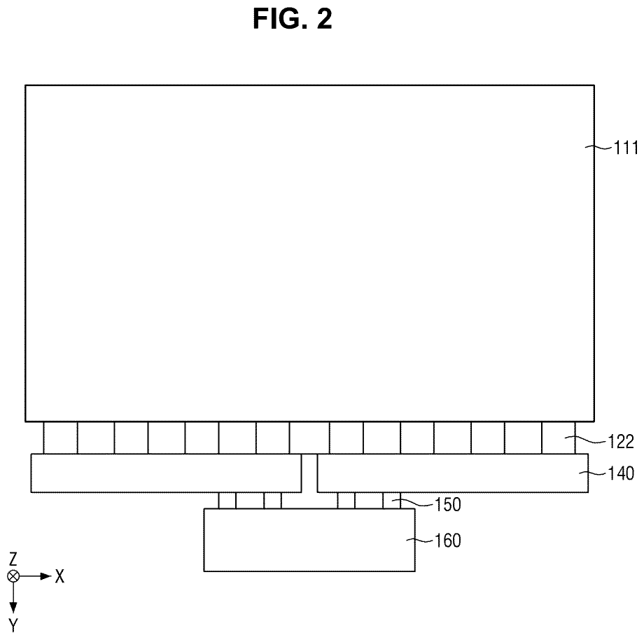

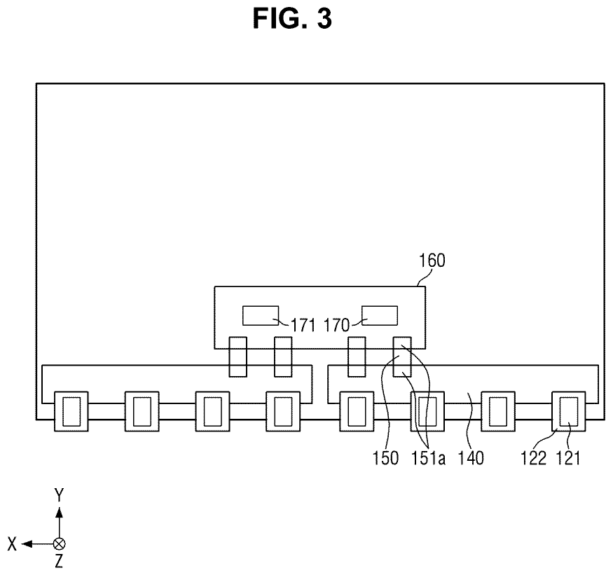

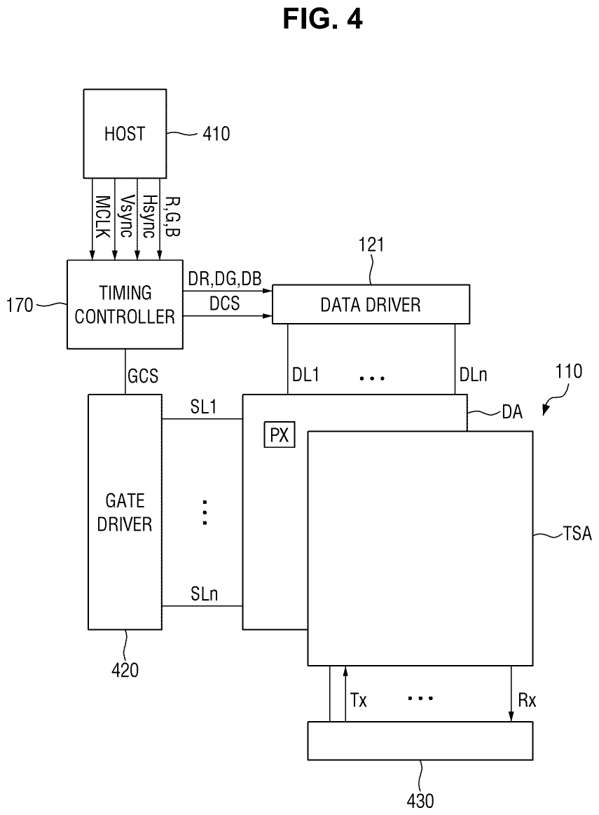

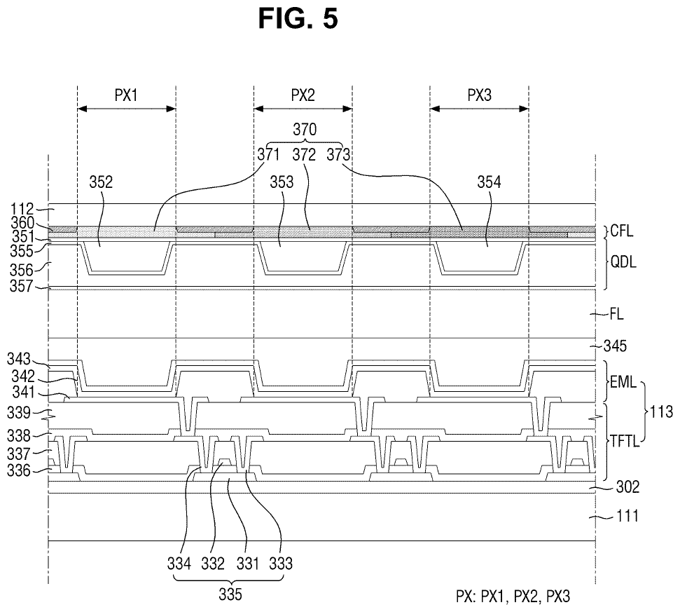

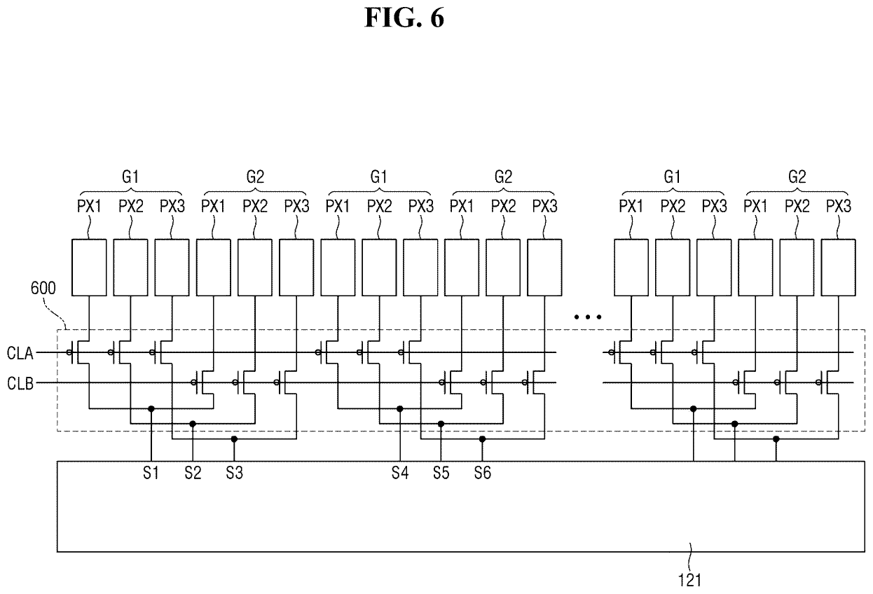

FIG. 1 is an exploded, perspective view of a display device according to some embodiments of the present disclosure. FIG. 2 is a bottom view showing an example of a display panel when the flexible films of FIG. 1 are unfolded, according to some embodiments of the present disclosure. FIG. 3 is a bottom view showing an example of the display panel when the flexible films of FIG. 1 are folded, according to some embodiments of the present disclosure. FIG. 4 is a block diagram of a display device according to some embodiments of the present disclosure. FIG. 5 is a cross-sectional view showing an example of a first substrate, a second substrate and a pixel array layer of a display panel, according to some embodiments of the present disclosure. FIG. 6 is a diagram for conceptually illustrating output terminals of a data driver and a switching unit according to some embodiments of the present disclosure.

Referring to FIGS. 1 to 3, a display device 10 according to some exemplary embodiments of the present disclosure may be employed by mobile electronic devices, such as a mobile phone, a smart phone, a tablet PC, a mobile communications terminal, an electronic notebook, an electronic book, a portable multimedia player (PMP), a navigation device and a ultra mobile PC (UMPC). In some examples, the display device 10 may be used as a display unit of a television, a laptop computer, a monitor, an electronic billboard, or the Internet of Things (IoT). Alternatively, the display device 10 according to some embodiments of the present disclosure may be applied to wearable devices such as a smart watch, a watch phone, a glasses-type display, and a head-mounted display (HMD) device. Alternatively, the display device 10 according to some embodiments may be used as a center information display (CID) disposed (e.g., positioned/located) at the instrument cluster, the center fascia or the dashboard of a vehicle, as a room mirror display on the behalf of the side mirrors of a vehicle, as a display placed on the back of each of the front seats that is an entertainment system for passengers at the rear seats of a vehicle.

Referring to FIG. 1, the display device 10 according to some embodiments of the present disclosure includes a top set cover 101, a bottom set cover 102, a display panel 110, data drivers 121, flexible films 122, source circuit boards 140, first cables 150, a control circuit board 160, a power circuit 171 and a timing controller 170.

As used herein, the terms “on”, “top” and “upper surface” refer to the side of the first substrate 111 of the display panel 110 where the second substrate 112 is disposed, i.e., a side of the first substrate facing in the direction indicated by a third direction (z-axis direction), whereas the terms “under”, “bottom” and “lower surface” refer to the opposite side of the first substrate 111 of the display panel 110 where a heat dissipation film 130 is disposed, i.e., a side of the first substrate facing the opposite direction to the third direction (z-axis direction). As used herein, the terms “left,” “right,” “upper” and “lower” sides indicate relative positions when the display panel 110 is viewed from the top. For example, the “left side” refers to the side indicated by the first direction (x-axis direction), the “right side” refers to the opposite side to the side indicated by the first direction (x-axis direction), the “upper side” refers to the side indicated by the second direction (y-axis direction), and the “lower side” refers to the opposite side to the side indicated by the second direction (y-axis direction).

The upper set cover 100 may be disposed to cover edges of the upper surface of the display panel 110. The upper set cover 100 may cover the non-display area of the display panel 110 excluding the display area. The bottom set cover 102 may cover the source circuit boards 140, the first cables 150 and the control circuit board 160 when the flexible films 122 are bent such that the source circuit boards 140, the first cables 150 and the control circuit board 160 are disposed on under the display panel 110.

The top set cover 100 and the bottom set cover 102 may be made of plastic, metal, and/or the like.

The display panel 110 may have a rectangular shape. For example, the display panel 110 may have a rectangular shape having longer sides in a first direction (e.g., the x-axis direction) and shorter sides in a second direction (e.g., the y-axis direction) when viewed from the top as shown in FIG. 2. The corners where the shorter sides in the first direction (e.g., the x-axis direction) meet the longer sides in the second direction (e.g., the y-axis direction) may be a right angle or may be rounded with a set or predetermined curvature. The shape of the display panel 110 when viewed from the top is not limited to a rectangular shape, but may be formed in a different polygonal shape, a circular shape, an elliptical shape, or any other suitable shape.

Although the flat display panel 110 is shown in FIG. 2, this is merely illustrative. The display panel 110 may include a curved portion that is bent at a set or predetermined curvature.

The display panel 110 may include a first substrate 111 and a second substrate 112. The second substrate 112 may be disposed such that it faces the first substrate 111. The first substrate 111 and the second substrate 112 may be either rigid or flexible. The first substrate 111 may include glass, plastic, and/or the like. The second substrate 112 may include glass, plastic, an encapsulation film 345 (or an encapsulation layer; see, e.g., FIG. 5), or a barrier film.

According to some embodiments, the second substrate 112 may be omitted.

When the first substrate 111 and the second substrate 112 are made of a plastic, the plastic may be polyethersulphone (PES), polyacrylate (PA), polyacrylate (PAR), polyetherimide (PEI), polyethylenenapthalate (PEN), polyethyleneterepthalate (PET), polyphenylenesulfide (PPS), polyallylate, polyimide (PI), polycarbonate (PC), cellulosetriacetate (CAT), cellulose acetate propionate (CAP), or a combinations thereof. The encapsulation film or the barrier film may be a stack of multiple inorganic layers.

The display panel 110 may be an organic light-emitting display panel using organic light-emitting diodes each including a first electrode (e.g., an anode electrode 341 of FIG. 5), an organic light-emitting layer (e.g., an emissive layer 342 of FIG. 5) and a second electrode (e.g., a cathode electrode 343 of FIG. 5), an inorganic light-emitting display panel using inorganic light-emitting diodes each including a first electrode, an inorganic semiconductor layer and a second electrode, or a quantum-dot light-emitting display panel including quantum-dot light-emitting diodes each including a first electrode, a quantum-dot light-emitting layer, and a second electrode.

In the following description, an organic light-emitting display panel that includes a thin-film transistor layer TFTL (see, e.g., FIG. 5), an emission material layer EML (see, e.g., FIG. 5), a filler FL (see, e.g., FIG. 5), a wavelength conversion layer QDL (see, e.g., FIG. 5) and a color filter layer CFL (see, e.g., FIG. 5) disposed between the first substrate 111 and the second substrate 112 is employed as the display panel 100.

The first substrate 111 may be a thin-film transistor substrate on which the thin-film transistor layer TFTL, the emission material layer EML, and the encapsulation film 345 are formed. The second substrate 112 may be a color filter substrate on which the wavelength conversion layer QDL and the color filter layer CFL are formed. The filler FL may be disposed between the encapsulation film 345 (see, e.g., FIG. 5) of the first substrate 111 and the wavelength conversion layer QDL of the second substrate 112.

According to some embodiments of the present disclosure, the second substrate 112 of the display panel 110 may be eliminated, and the encapsulation film 345 may be disposed on the emission material layer EML. In such a case, the filler FL may be eliminated, and a wavelength conversion layer QDL and the color filter layer CFL may be disposed on the encapsulation film 345.

One end of each of the flexible films 122 may be disposed on a first surface of the first substrate 111 of the display panel 110 while the other end thereof may be attached on a surface of the respective source circuit boards 140.

Because the first substrate 111 is larger than the second substrate 112, one side of the first substrate 111 may not be covered by the second substrate 112 but is exposed. The flexible films 122 may be attached to the side of the first substrate 111 exposed without being covered by the second substrate 112. Each of the flexible films 122 may be attached to a first surface of the first substrate 111 and the surface of the respective source circuit boards 140 using an anisotropic conductive film.

Each of the flexible films 122 may be a tape carrier package or a chip-on-film. The flexible films 122 may be bent such that they are located under the first substrate 111. Although FIG. 1 illustrates that the eight flexible films 122 are attached on the first substrate 111 of the display panel 110, the number of the flexible films 122 is not limited to eight, and any suitable number of flexible films 122 may be utilized.

The data drivers 121 may be disposed on the surfaces of the flexible films 122, respectively. Each of the data drivers 121 may be implemented as an integrated circuit (IC).

As used herein, the data drivers 121 may be referred to by terms such as “source driver circuits,” “source drivers,” and “data driver circuits.”

Each of the data drivers 121 converts digital image data DR, DG, and DB (see, e.g., FIG. 4) into analog data voltages in response to a source control signal DCS (see, e.g., FIG. 4) from the time controller 170 and supplies the analog data voltages to data lines DL1 to DLn (see, e.g., FIG. 4) of the display panel 110 through the flexible films 122.

According to some embodiments, a switching unit 600 (e.g., a switching circuit; see, e.g., FIG. 6) may be disposed between the data drivers 121 and the data lines DL1 to DLn. The switching unit 600 (see, e.g., FIG. 6) may receive analog data voltage output from the data drivers 121 and may switch the received analog data voltage to supply it to the data lines DL1 to DLn. This switching unit 600 (see, e.g., FIG. 6) may be a demultiplexer. According to some embodiments, at least some of the data drivers 121 may be referred to as a display driver IC (DDI).

The display panel 110 may include scan lines SL1 to SLn crossing the data lines DL1 to DLn, and pixels PX (see, e.g., FIG. 4) arranged at crossings defined by the data lines DL1 to DLn and the scan lines SL1 to SLn. The scan lines SL1 to SLn (see, e.g., FIG. 4) may receive scan signals from a gate driver 420 (see, e.g., FIG. 4) formed in the display panel 110. The gate driver 420 may include a plurality of thin-film transistors and may generate scan signals in response to a scan control signal GCS (see, e.g., FIG. 4) of the timing controller 170.

Each of the pixels PX is connected to at least one of the data lines DL1 to DLn and at least one of the scan lines SL1 to SLn. When a scan signal is supplied to the scan lines SL1 to SLn, each of the pixels PX receives a data voltage from the data lines DL1 to DLn.

Each of the source circuit boards 140 may be connected to the control circuit board 160 via the first cables 150. Each of the source circuit boards 140 may include first connectors 151 for connecting to the first cables 150. Each of the source circuit boards 140 may be a flexible printed circuit board or a printed circuit board. The first cables 150 may be flexible cables.

The control circuit board 160 may be connected to the source circuit boards 140 via the first cables 150. To this end, the control circuit board 160 may include second connectors 152 for connecting to the first cables 150.

Although four first cables 150 connect the source circuit boards 140 with the control circuit board 160 in the example shown in FIG. 2, the number of the first cables 150 is not limited to four, and any suitable number of first cables 150 may be utilized. In addition, although two source circuit boards 140 are shown in FIG. 2, the number of the source circuit boards 140 is not limited two, and any suitable number of source circuit boards 140 may be utilized.

According to some embodiments of the present disclosure, when there are a small number of the flexible films 122, the source circuit boards 140 may be eliminated. In such a case, the flexible films 122 may be connected directly to the control circuit board 160.

The timing controller 170 may be disposed on one surface of the control circuit board 160. The timing controller 170 may be implemented as an integrated circuit. The timing controller 170 may receive digital image data R, G and B (see, e.g., FIG. 4) and timing signals MCLK, Vsync and Hsync (see, e.g., FIG. 4) from a system-on-chip (e.g., host 410 in FIG. 4) of a system circuit board, and may generate a source control signal DCS (see, e.g., FIG. 4) for controlling the timing of the data drivers 121 in response to the timing signals MCLK, Vsync and Hsync (see, e.g., FIG. 4).

The power circuit 171 may be disposed on a surface of the control circuit board 160. The power circuit 171 may be implemented as an integrated circuit. The power circuit 171 generates voltages that are used to drive the display panel 110 based on a main power supplied from the system circuit board. For example, the power circuit 171 may generate a high-level voltage, a low-level voltage, and an initialization voltage for driving the organic light-emitting elements and may supply the generated voltages to the display panel 110. In addition, the power circuit 171 may generate driving voltages for driving the data drivers 121, the timing controller 170, and other components.

It should be noted that although the display device 10 according to some embodiments of FIG. 1 is a middle- or large-sized display device including the plurality of data drivers 121, this is merely illustrative. For example, the display device 10 according to some embodiments may be a small-sized display device including a single data driver 121. In such a case, the flexible films 122 and the source circuit boards 140 and the cables 150 may be eliminated. The data driver 121 and the timing controller 170 may be integrated into a single integrated circuit to be attached onto a single flexible circuit board or to be attached onto the first substrate 111 of the display panel 110. Examples of the middle- or large-sized display devices include monitors, and television sets, and the like, and examples of small-sized display devices include smart phones, tablet PCs, and the like.

Referring to FIGS. 2 and 3, a first surface of the first substrate 111 and a second surface of the second substrate 112 may face each other. A pixel array layer 113 (see, e.g., FIG. 5) may be disposed between the first surface of the first substrate 111 and the first surface of the second substrate 112. The pixel array layer 113 may include a plurality of pixels PX1, PX2, and PX3 emitting light.

A heat dissipation film may be disposed on the second surface of the first substrate 111. The heat dissipation layer may include a metal layer such as graphite, silver (Ag), copper (Cu), aluminum (AI), and/or the like, which has a high thermal conductivity.

The flexible films 122 are bent such that they are located under the bottom chassis 180 and may be attached to the source circuit board 140 on a surface of the bottom chassis 180. The source circuit boards 140 and the control circuit board 160 may be disposed on a surface of the bottom chassis 180 and may be connected to one another through the first cables 150.

The timing controller 170 and the power circuit 171 may be disposed on the control circuit board 160.

FIG. 4 is a block diagram of a display device according to some embodiments of the present disclosure. For example, FIG. 4 is a diagram conceptually showing a display unit and a touch driver according to some embodiments.

Referring to FIG. 4, a display device 10 may include a display panel 110 including a plurality of pixels PX, a data driver 121, a gate driver 420 and a timing control 170. According to some embodiment, the display panel 110 of the display device 10 may include a touch sensing area TSA for sensing a touch. In such examples, the display device 10 may further include a touch driver circuit 430.

The timing controller 170 and the touch driver circuit 430 may operate based on a control signal or a command signal from the host 410. For example, the host 410 may be an application processor. According to some embodiments, the touch driver circuit 430 may be controlled by the timing controller 170.

The timing controller 170 may receive digital image data R, G and B and timing signals MCLK, Vsync and Hsync from the host 410. The timing signals MCLK, Vsync and Hsync may include a vertical synchronization signal Vsync indicating one frame period, a horizontal synchronization signal Hsync indicating one horizontal period, and a main clock MCLK repeated with a set or predetermined period.

The digital image data R, G and B may be RGB data including red image data, green image data, and blue image data. The timing controller 170 may generate digital image data DR, DG, and DB and internal control signals using the received digital image data R, G and B and the timing signals MCLK, Vsync and Hsync. The internal control signals include a data control signal DCS and a gate control signal GCS. In the following description, the digital image data DR, DG, and DB output by the timing controller 170 will be referred to as output data signals DR, DG, and DB.

The timing controller 170 may control the operation of the data driver 121 by providing the data control signal DCS to the data driver 121. The timing controller 170 may control the operation of the gate driver 420 by providing the gate control signal GCS to the gate driver 420.

The data driver 121 may receive the output data signals DR, DG, and DB and the data control signal DCS from the timing controller 170. The data driver 121 may generate a data signal using the output data signals DR, DG, and DB and the data control signal DCS. The data driver 121 may provide the generated data signal to the display panel 110. The data driver 121 may provide data signals to the plurality of pixels PX through a plurality of data lines DL1 to DLn formed in the display panel 110.

According to some embodiments, a switching unit 600 (e.g., a switching circuit; see, e.g., FIG. 6) may be disposed between the data drivers 121 and the data lines DL1 to DLn. The switching unit 600 (see, e.g., FIG. 6) may receive analog data voltage output from the data drivers 121 and may switch the received analog data voltage to supply it to the data lines DL1 to DLn. This switching unit 600 (see, e.g., FIG. 6) may be a demultiplexer.

The gate driver 420 may receive the gate control signal GCS from the timing controller 170. The gate driver 420 may generate a gate signal using the received gate control signal GCS. The gate driver 420 may provide the generated gate signal to the display panel 110. The gate driver 420 may provide gate signals to the plurality of pixels PX through a plurality of gate lines SL1 to SLn formed in the display panel 110.

The gate driver 420, the data driver 121, and the timing controller 170 may be implemented as integrated circuits (ICs). The gate driver 420 may be formed together during a process of fabricating thin-film transistors of the display panel 110. The timing controller 170 and the data driver 121 may be merged to form a timing controller embedded driver (TED) integrated circuit.

A frame frequency at which the timing controller 170 drives the display panel 110 may be variable. For example, the frame frequency may vary within the range of 1 Hz to 240 Hz pursuant to a command from a host.

The touch sensing area TSA may include a plurality of first electrodes, a plurality of second electrodes crossing the plurality of first electrodes, a plurality of touch driving lines Tx, and a plurality of touch sensing lines Rx. The touch driver circuit 430 may sense a touch input by converting an analog electrical signal detected by the touch sensing area TSA into a digital signal.

FIG. 5 is a cross-sectional view showing an example of a first substrate, a second substrate and a pixel array layer of a display panel.

Referring to FIG. 5, the display panel 110 may include a first substrate 111, a second substrate 112, and a pixel array layer 113. The pixel array layer 113 may include a thin-film transistor layer TFTL and an emission material layer EML.

A buffer layer (or a buffer film) 302 may be formed on one surface of the first substrate 111 that faces the second substrate 112. The buffer layer 302 may be formed on the first substrate 111 to protect the thin-film transistors 335 and the light-emitting elements from moisture permeating through the first substrate 111 that is susceptible to moisture permeation.

A thin-film transistor layer TFTL is formed on the buffer layer 302. The thin-film transistor layer TFTL includes thin-film transistors 335, a gate insulating layer 336, an interlayer dielectric layer 337, a protective layer 338, and a planarization layer 339.

The thin-film transistor 335 includes an active layer 331, a gate electrode 332, a source electrode 333 and a drain electrode 334. The active layer 331 may be formed of a silicon-based semiconductor material, an oxide-based semiconductor material, and/or the like. A light-blocking layer for blocking external light incident on the active layer 331 may be formed between the buffer film and the active layer 331.

The emission material layer EML is formed on the thin-film transistor layer TFTL. The emission material layer EML includes light-emitting elements and a pixel-defining layer. The light-emitting elements and the pixel-defining layer are formed on the planarization layer 339. The light-emitting element may be an organic light-emitting device. The light-emitting element may include an anode electrode 341, an emissive layer 342, and a cathode electrode 343.

The pixel-defining layer may cover the edge of the anode electrode 341 on the planarization layer 339 in order to separate the pixels from one another. The pixel-defining layer 344 serves to define sub-pixels PX1, PX2, and PX3. In each of the sub-pixels PX1, PX2, and PX3, the anode electrode 341, the emissive layer 342, and the cathode electrode 343 are sequentially stacked on one another so that holes from the anode electrode 341 and electrons from the cathode electrode 343 combine in the emissive layer 342 to emit light.

The emissive layers 342 may be organic emissive layers. The emissive layer 342 may emit light having a short wavelength such as blue light and ultraviolet light. The peak wavelength range of blue light may be about 450 nm to about 490 nm, and the peak wavelength range of ultraviolet light may be less than 450 nm. In such a case, the emissive layer 342 may be a common layer formed across the sub-pixels PX1, PX2, and PX3. In such a case, the display panel 110 may include a wavelength conversion layer QDL for converting light of a short wavelength such as blue light and ultraviolet light emitted from the emissive layer 342 into red light, green light and blue light, and a color filter layer CFL that transmits red light, green light, and blue light.

The emissive layer 342 may include a hole transporting layer, a light-emitting layer, and an electron transporting layer. In addition, the emissive layer 342 may be formed in a tandem structure of two or more stacks, in which case a charge generating layer may be formed between the stacks.

The cathode electrode 343 is formed on the emissive layer 342. The second electrode 343 may be formed to cover the emissive layer 342. The second electrode 343 may be a common layer formed across the pixels.

An encapsulation film 345 is formed on the light-emitting element layer EML. The encapsulation film 345 serves to prevent or substantially reduce permeation of oxygen or moisture into the emissive layer 342 and the cathode electrode 343. To this end, the encapsulation film 345 may include at least one inorganic film and at least one organic film.

The color filter layer CFL is disposed on the surface of the second substrate 112 facing the first substrate 111. The color filter layer CFL may include a black matrix 360 and color filters 370.

The black matrix 360 may be formed on one surface of the second substrate 112. The black matrix 360 may be disposed such that it overlaps with the pixel-defining layer 344 but not with the sub-pixels PX1, PX2, and PX3. The black matrix 360 may include a black dye that may block light without transmitting it, or may include an opaque metal material.

The color filters 370 may overlap with the sub-pixels PX1, PX2, and PX3. The first color filters 371 may overlap the first sub-pixels PX1, respectively. The second color filters 372 may overlap with the second sub-pixels PX2, respectively. The third color filters 373 may overlap with the third sub-pixels PX3, respectively. In such examples, the first color filters 371 may be light transmission filters of a first color that transmit light of the first color. The second color filters 372 may be light transmission filters of a second color that transmit light of the second color. The third color filters 373 may be light transmission filters of a third color that transmit light of the third color. For example, the first color may be red, the second color may be green, and the third color may be blue. It is, however, to be understood that the present disclosure is not limited thereto. In such a case, the peak wavelength range of the red light passing through the first color filters 371 may be about 620 nm to about 750 nm. The peak wavelength range of the green light passing through the second color filters 372 may be about 500 nm to about 570 nm. The peak wavelength range of the blue light passing through the third color filter 373 may be about 450 nm to about 490 nm.

The wavelength conversion layer QDL is disposed on the color filter layer CFL. The wavelength conversion layer QDL may include a first capping layer 351, a first wavelength conversion layer 352, a second wavelength conversion layer 353, a third wavelength conversion layer 354, a second capping layer 355, an interlayer organic layer 356, and a third capping layer 357.

The filler FL may be disposed between the encapsulation film 345 disposed on the first substrate 111 and the third capping layer 357 disposed on the second substrate 112. The filler FL may be made of a material having shock-absorbing function.

A sealing material for attaching the first substrate 111 to the second substrate 112 may be disposed in the non-display area of the display panel 110. When viewed from the top, the filler material FL may be surrounded by the sealing material. The sealing material may be a glass frit or a sealant.

Referring to FIG. 6, a display panel 110 according to some embodiments may include a switching unit 600. The switching unit 600 is disposed between the data drivers 121 and the data lines DL1 to DLn. The switching unit 600 (see, e.g., FIG. 6) may receive analog data voltage output from the data drivers 121 and may switch the received analog data voltage to supply it to the data lines DL1 to DLn. This switching unit 600 (see, e.g., FIG. 6) may be a demultiplexer.

According to some embodiments, the switching unit 600 may be disposed in the non-display area of the display panel 110. For example, the switching unit 600 may be disposed in the non-display area of the display panel 110 and may include a plurality of thin-film transistors. The switching unit 600 may include first transistors (e.g., a first switching unit) that are turned on or off in response to a first switching signal CLA output from the timing controller 170, and second transistors (e.g., a second switching unit) that are turned on or off in response to a second switching signal CLB output from the timing controller 170.

The first switching signal CLA and the second switching signal CLB for controlling the first and second transistors of the switching unit 600 may be output alternately during one frame. For example, the timing controller 170 may alternately output the first switching signal CLA and the second switching signal CLB during one frame. Accordingly, the first transistors and the second transistors may be turned on alternately during one frame period (e.g., the on-times of the first and second transistors may not overlap).

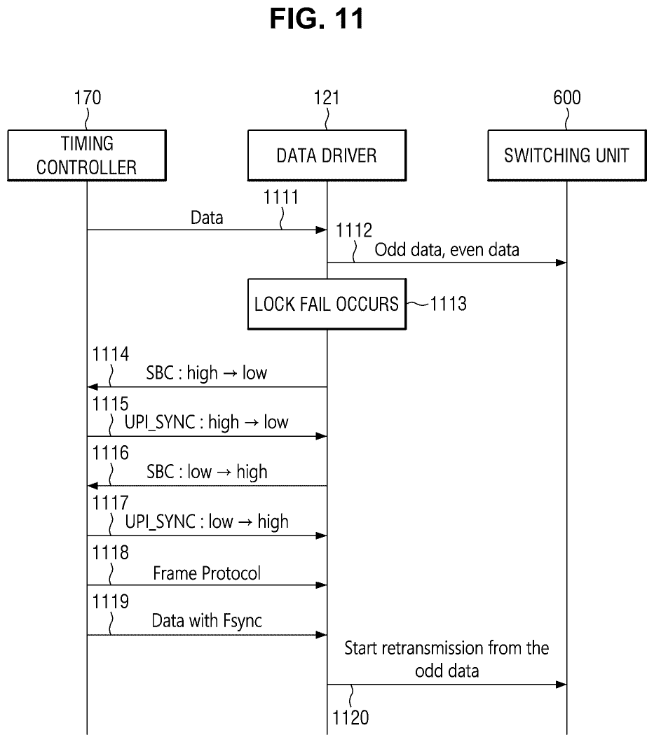

When the first transistors of the switching unit 600 are turned on by the first switching signal CLA, they provide first image data (e.g., odd data in FIG. 11) output from the output terminals S1 to S6 of the data driver 121 to sub-pixels of the first group G1 among the plurality of sub-pixels included in the display panel 110. The first image data (e.g., odd data) refers to image data delivered by the timing controller 170 to the data driver 121 to be supplied to the sub-pixels of the first group G1.

The sub-pixels of the first group G1 refer to odd sub-pixels arranged in odd columns among the plurality of sub-pixels PX1, PX2, and PX3 included in the display panel 110. That is to say, the sub-pixels included in pixels in odd columns may be defined as the sub-pixels of the first group G1. For example, the first sub-pixels PX1 displaying red may be arranged in a matrix in the display panel 110, and the first sub-pixels PX1 arranged in odd columns among the first sub-pixels PX1 may be defined as the sub-pixel of the first group G1. Among the first sub-pixels PX1, the first sub-pixels PX1 arranged in the odd columns may receive first image data (e.g., odd data) output from the output terminals S1 to S6 of the data driver 121 through the first transistors of the switching unit 600.

When the second transistors of the switching unit 600 are turned on by the second switching signal CLB, they provide second image data (e.g., even data in FIG. 11) output from the output terminals S1 to S6 of the data driver 121 to sub-pixels of the second group G2 among the plurality of sub-pixels included in the display panel 110. The second image data (e.g., even data) refers to image data delivered by the timing controller 170 to the data driver 121 to be supplied to the sub-pixels of the second group G2.

The sub-pixels of the second group G2 refer to odd sub-pixels arranged in even columns among the plurality of sub-pixels PX1, PX2, and PX3 included in the display panel 110. That is to say, the sub-pixels included in pixels in even columns may be defined as the sub-pixels of the second group G2. For example, the first sub-pixels PX1 displaying red may be arranged in a matrix in the display panel 110, and the first sub-pixels PX1 arranged in even columns among the first sub-pixels PX1 may be defined as the sub-pixel of the second group G2. Among the first sub-pixels PX1, the first sub-pixels PX1 arranged in the even columns may receive second image data (e.g., even data) output from the output terminals S1 to S6 of the data driver 121 through the second transistors of the switching unit 600.

Although the switching unit 600 according to some embodiments described above with reference to FIG. 6 is a 2:1 demultiplexer, the switching unit 600 is not limited thereto. For example, the switching unit 600 may be a 3:1 demultiplexer or a 4:1 demultiplexer.

If the switching unit 600 is implemented as a 3:1 demultiplexer, the switching unit 600 may include first transistors that are turned on or off in response to a first switching signal CLA output from the timing controller 170, second transistors that are turned on or off in response to the second switching signal CLB output from the timing controller 170, and third transistors that are turned on or turned off in response to a third switching signal output from the timing controller 170. In such examples, the plurality of sub-pixels may be divided into a first group receiving first image data from the first transistors, a second group receiving second image data from the second transistors, and a third group receiving third image data from the third transistors.

If the switching unit 600 is implemented as a 4:1 demultiplexer, the switching unit 600 may include first transistors that are turned on or off in response to the first switching signal CLA output from the timing controller 170, second transistors that are turned on or off in response to the second switching signal CLB output from the timing controller 170, third transistors that are turned on or turned off in response to the third switching signal output from the timing controller 170, and fourth transistors that are turned on or turned off in response to the fourth switching signal output from the timing controller 170. In such examples, the plurality of sub-pixels may be divided into a first group receiving first image data from the first transistors, a second group receiving second image data from the second transistors, a third group receiving third image data from the third transistors, and a fourth group receiving fourth image data from the fourth transistors.

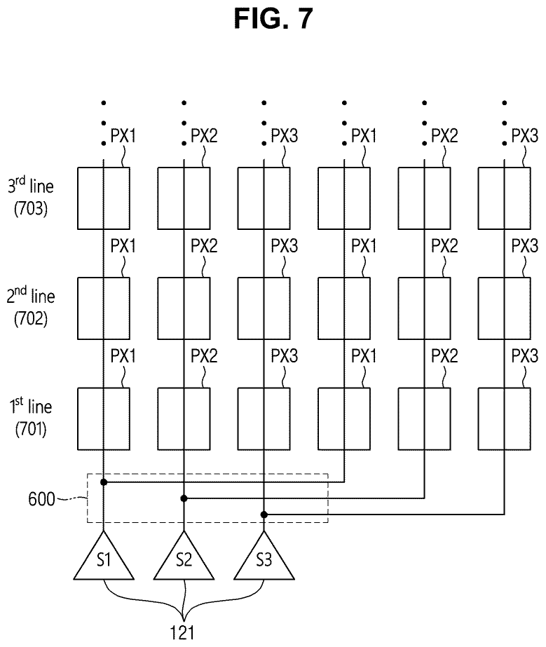

FIG. 7 is a diagram for illustrating connection relationships between a switching unit 600 and a plurality of sub-pixels according to some embodiments of the present disclosure.

Referring to FIG. 7, the output terminals of the data driver 121 according to some embodiments may include a first output terminal S1 that outputs image data to be supplied to a first sub-pixel, a second output terminal S2 that outputs image data to be supplied to a second sub-pixel, and a third output terminal S3 that outputs image data to be supplied to a third sub-pixel. For example, the first output terminal S1 may output red image data to be supplied to the first sub-pixel PX1, the second output terminal S2 may output green image data to be supplied to the second sub-pixel PX2, and the third output terminal S3 may output blue image data to be supplied to the third sub-pixel PX3.

According to some embodiments, the output terminals S1, S2, and S3 of the data driver 121, i.e., the first output terminal S1, the second output terminal S2 and the third output terminal S3 output image data to each of the horizontal line 701, 702, and 703 one after another, and output first image data (e.g., odd data) for odd sub-pixels and second image data (e.g., even data) for odd sub-pixels sequentially during one horizontal period. For example, the first output terminal S1 outputs red image data to be supplied to the first sub-pixels PX1, and outputs first red image data for odd sub-pixels and second red image data for even sub-pixels sequentially during one horizontal period.

FIG. 7 shows the first horizontal line 701, the second horizontal line 702, and the third horizontal line 703.

According to some embodiments, the switching unit 600 supplies the first image data (e.g., odd data) input from the output terminals of the data driver 121 to the sub-pixels of the first group G1, i.e., the odd sub-pixels. For example, the first transistors of the switching unit 600 are turned on in synchronization with the timing at which the output terminals S1, S2, and S3 of the data driver 121 output the first image data (e.g., odd data), and accordingly the first image data (e.g., odd data) output from the output terminals S1, S2, and S3 of the data driver 121 is supplied to the sub-pixels of the first group G1, i.e., odd sub-pixels through the switching unit 600.

According to some embodiments, the switching unit 600 supplies the second image data (e.g., even data) input from the output terminals of the data driver 121 to the sub-pixels of the second group G2, i.e., the even sub-pixels. For example, the second transistors of the switching unit 600 are turned on in synchronization with the timing at which the output terminals S1, S2, and S3 of the data driver 121 output the second image data (e.g., even data), and accordingly the second image data (e.g., even data) output from the output terminals S1, S2, and S3 of the data driver 121 is supplied to the sub-pixels of the second group G2, i.e., even sub-pixels through the switching unit 600.

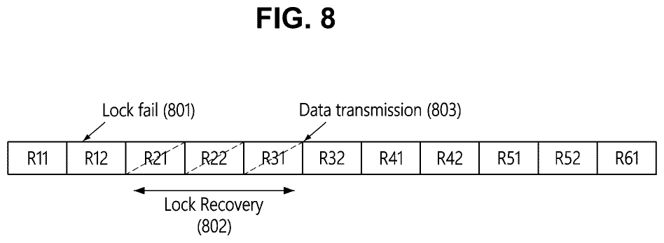

FIG. 8 is a diagram for conceptually showing a case in which a lock fail occurs in a data driver of a display device according to a comparative example.

Referring to FIG. 8, in the display device according to the comparative example, a timing controller may transmit image data to the data driver using a predetermined interface. For example, the predetermined interface can be one of high speed serial interface, universal serial interface (USI), universal serial interface for TV (USI-T), universal description, discovery and integration (UDDI), or the like.

According to the comparative example, if image data is abnormally received due to static electricity, noise, or the like, the data driver 121 may determine that the clock signal has a lock fail (e.g., a phase lock fail).

According to the comparative example, if it is determined that a lock fail occurred while receiving image data, the data driver 121 may transmit a first control signal SBC to the timing controller 170. The first control signal SBC may be a clock signal. If the data driver 121 determines that a lock fail occurred while receiving image data, it may transition the first control signal SBC from a high state ST1 (e.g., first state) to a low state ST2 (e.g., a second state).

According to the comparative example, the timing controller 170, upon receiving the first control signal SBC from the data driver 121, identifies that a lock fail of the clock signal occurred in the data driver 121. Once the timing controller 170 identifies the lock fail of the data driver 121, it transmits a clock training signal 1001 to the data driver 121 for lock (e.g., a phase lock) recovery.

According to the comparative example, when transmission of the clock training signal 1001 is completed, the timing controller 170 determines that the lock recovery in the data driver 121 has been completed and resumes transmission of image data.

Unfortunately, the display device according to the comparative example has a problem that the data driver 121 cannot distinguish the type of image data input from the timing controller 170 when the timing controller 170 resumes transmission of image data. For example, when image data is retransmitted, the data driver 121 cannot distinguish whether the received image data is first image data (e.g., odd data) or second image data (e.g., even data). As a result, in the display device according to the comparative example, when a lock fail occurs in the data driver 121, an error such as one shown in FIG. 8 and Table 1 may occur during the recovery process.

Table 1 summarizes FIG. 8 and describes image data sequentially output from the timing controller 170 according to the comparative example.

TABLE 1

| Image Data | Horizontal Line | Even/Odd | Remark |
|---|---|---|---|
| R11 | First Horizontal Line | Odd | Normal |
| R12 | First Horizontal Line | Even | Lock fail |
| R21 | Second Horizontal Line | Odd | Lock recovery |
| R22 | Second Horizontal Line | Even | Lock recovery |
| R31 | Third Horizontal Line | Odd | Lock recovery |
| R32 | Third Horizontal Line | Even | Start Retransmission |
| | | | (Mismatched) |
| R41 | Fourth Horizontal Line | Odd | Mismatched |
| R42 | Fourth Horizontal Line | Even | Mismatched |
| R51 | Fifth Horizontal Line | Odd | Mismatched |
| R52 | Fifth Horizontal Line | Even | Mismatched |
| R61 | Sixth Horizontal Line | Odd | Mismatched |

Referring to FIG. 8 and Table 1, when the timing controller 170 according to the comparative example outputs image data R12, which is image data to be supplied to the even sub-pixels of the first horizontal line, it identifies a lock fail 801 of the data driver 121. After identifying the lock fail of the data driver 121, the timing controller according to the comparative example transmits a clock training signal 1001 to the data driver 121 for a set or predetermined period of time to conduct lock recovery 802.

When transmission of the clock training signal 1001 is completed, the timing controller 170 according to the comparative example determines that the lock recovery in the data driver 121 has been completed and resumes transmission of image data. In the example of FIG. 8 and Table 1, after the timing controller 170 according to comparative example determines the completion of the lock recovery, retransmission is started with image data R32, which is image data to be supplied to the even sub-pixels of the third horizontal line.

Unfortunately, the data driver 121 according to the comparative example cannot distinguish whether the image data R32 input from the timing controller 170 is first image data (e.g., odd data) for odd sub-pixels or second image data for even sub-pixels. (e.g., even data). Accordingly, after the timing controller 170 starts retransmitting the image data R32, there may be a problem in that the timing controller 170 and the data driver 121 are not mismatched, and that the switching operations between the data driver 121 and the switching unit 600 are not mismatched.

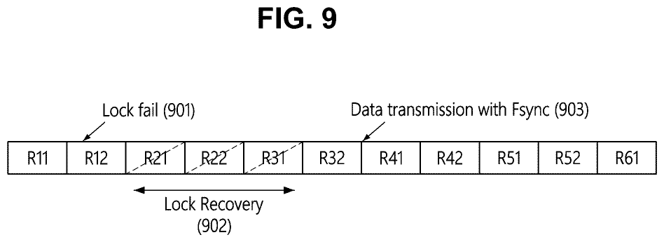

Hereinafter, some embodiments of the present disclosure to solve the problem according to the comparative example will be described with reference to FIGS. 9 to 13.

FIG. 9 is a diagram for conceptually showing a case in which a lock fail occurred in a data driver 121 of a display device 10 according to some embodiments of the present disclosure.

In the display device according to some embodiments of the present disclosure, a timing controller may transmit image data to the data driver 121 using a predetermined interface. For example, the predetermined interface can be one of high speed serial interface, universal serial interface (USI), universal serial interface for TV (USI-T), and universal description, discovery and integration (UDDI).

According to some embodiments of the present disclosure, if image data is abnormally received from the timing controller 170 due to static electricity or the like, the data driver 121 may determine that the clock signal has a lock fail.

According to some embodiments, if it is determined that a lock fail occurred while receiving image data, the data driver 121 may transmit a first control signal SBC to the timing controller 170. The first control signal SBC may be a clock signal. If the data driver 121 determines that a lock fail occurred while receiving image data, it may transition the first control signal SBC from a high state ST1 (e.g., a first state) to a low state ST2 (e.g., a second state).

According to some embodiments, the timing controller 170, upon receiving the first control signal SBC from the data driver 121, identifies that a lock fail of the clock signal occurred in the data driver 121. Once the timing controller 170 identifies the lock fail of the data driver 121, it transmits a clock training signal 1001 to the data driver 121 for lock recovery.

According to some embodiments, when transmission of the clock training signal 1001 is completed, the timing controller 170 determines that the lock recovery in the data driver 121 has been completed and resumes transmission of image data. According to some embodiments, the timing controller 170 may determine that the lock of the clock of the data driver 121 has been completed upon identifying that the first control signal SBC output from the data driver 121 transitions from the low state ST2 to the high state ST1.

The display device according to some embodiments of the present disclosure further outputs an identification signal Fsync to distinguish the type of image data input from the timing controller 170 when the timing controller 170 resumes transmission of image data. For example, when image data is retransmitted, the data driver 121 can distinguish whether the received image data is first image data (e.g., odd data) or second image data (e.g., even data) based on the identification signal Fsync. In this manner, when a lock fail occurs in the data driver 121, the display device according to some embodiments of the present disclosure can recover it as shown in the example of FIG. 9 and Table 2 during the recovery process.

Table 2 summarizes FIG. 9 and describes image data sequentially output from the timing controller 170 according to some embodiments.

TABLE 2

| Image Data | Horizontal Line | Even/Odd | Remark |
|---|---|---|---|
| R11 | First Horizontal Line | Odd | Normal |
| R12 | First Horizontal Line | Even | Lock fail |
| R21 | Second Horizontal Line | Odd | Lock recovery |
| R22 | Second Horizontal Line | Even | Lock recovery |
| R31 | Third Horizontal Line | Odd | Lock recovery |
| R32 | Third Horizontal Line | Even | — |
| R41 | Fourth Horizontal Line | Odd | Start Retransmission |
| | | | (matched) |
| R42 | Fourth Horizontal Line | Even | Matched |
| R51 | Fifth Horizontal Line | Odd | Matched |
| R52 | Fifth Horizontal Line | Even | Matched |
| R61 | Sixth Horizontal Line | Odd | Matched |

Referring to FIG. 9 and Table 2, when the timing controller 170 according to some embodiments outputs image data R12, which is image data to be supplied to the even sub-pixels of the first horizontal line, it identifies a lock fail 901 of the data driver 121. After identifying the lock fail of the data driver 121, the timing controller 170 according to some embodiments transmits a clock training signal 1001 to the data driver 121 for a set or predetermined period of time to conduct lock recovery (e.g., phase lock recovery) 902.

When transmission of the clock training signal 1001 is completed, the timing controller 170 according to some embodiments determines that the lock recovery in the data driver 121 has been completed and resumes transmission of image data. In the example of FIG. 9 and Table 2, after the timing controller 170 according to some embodiments determines the completion of the lock recovery, retransmission is started with image data R41, which is image data to be supplied to the odd sub-pixels of the fourth horizontal line. At this time, the timing controller 170 outputs an identification signal Fsync to the data driver 121 so that the data driver 121 can identify that the image data R41 is first image data (e.g., odd data) to be supplied to the odd sub-pixels (i.e., the sub-pixels of the first group G1).

The data driver 121 according to some embodiments may identify that image data R41 input from the timing controller 170 is the first image data (e.g., the odd data) for odd sub-pixels based on the identification signal Fsync. Accordingly, after the timing controller 170 starts retransmitting the image data R41, the timing controller 170 and the data driver 121 can be matched and the switching operations between the data driver 121 and the switching unit 600 can be matched. For such matching, the timing controller 170 may synchronize the timing of outputting the identification signal Fsync with the time point of outputting the first switching signal CLA for turning on the first transistors of the switching unit 600.

In this manner, the display device 10 according to some embodiments can reduce the number of data drivers 121 by including the switching unit 600. In addition, if a lock fail occurs while the timing controller 170 is transmitting image data for one frame to the data driver 121, the timing controller 170 can normally transmit the remaining horizontal line data after a short period of time (e.g., approximately 1 horizontal period to 3 horizontal periods) for the lock recovery. For example, let us assume that a display panel 110 has FHD (i.e., 1920*1080) resolution, and a lock fail occurred in the process of transmitting image data to the 500^{th} horizontal line. In such examples, the display device 10 according to some embodiments can conduct lock recovery on the 500^{th} to 501^{st} horizontal lines, and can normally transmit image data to the remaining 502^{nd} to 1080^{th} horizontal lines to display images normally.

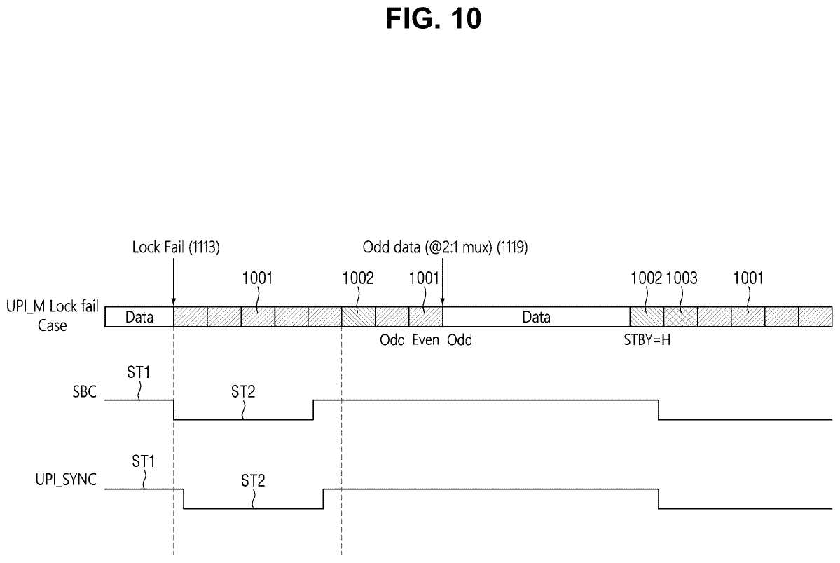

FIG. 10 is a timing diagram for illustrating output signals from the timing controller 170 and the data driver 121 when a lock fail occurs in the data driver 121 of the display device 10 according to some embodiments of the present disclosure. FIG. 11 is a signal diagram illustrating the operation of a display device 10 according to some embodiments of the present disclosure.

Hereinafter, the operation of the display device 10 according to some embodiments of the present disclosure will be described in detail with reference to FIGS. 10 and 11.

The timing controller 170 outputs image data to the data driver 121 (operation 1111). The timing controller 170 may transmit image data to the data driver 121 using a predetermined interface. For example, the predetermined interface can be one of high speed serial interface, universal serial interface (USI), universal serial interface for TV (USI-T), and universal description, discovery and integration (UDDI), or the like.

The data driver 121 receives the image data from the timing controller 170, divides the received image data into first image data (e.g., odd data) and second image data (e.g., even data), and outputs the first image data (e.g., odd data) and the second image data (e.g., even data) alternately to the switching unit 600 (operation 1112).

When the first transistors of the switching unit 600 are turned on by the first switching signal CLA, they provide first image data (e.g., odd data) output from the output terminals S1 to S6 of the data driver 121 to sub-pixels of the first group G1 among the plurality of sub-pixels included in the display panel 110.

When the second transistors of the switching unit 600 are turned on by the second switching signal CLB, they provide second image data (e.g., even data) output from the output terminals S1 to S6 of the data driver 121 to sub-pixels of the second group G2 among the plurality of sub-pixels included in the display panel 110.

If image data is abnormally received from the timing controller 170 due to static electricity or the like, the data driver 121 may determine that the clock signal has a lock fail (operation 1113).

If it is determined that a lock fail occurred while receiving image data, the data driver 121 may transmit a first control signal SBC to the timing controller 170 (Operation 1114). The first control signal SBC may be a clock signal. If the data driver 121 determines that a lock fail occurred while receiving image data, it may transition the first control signal SBC from a high state ST1 (e.g., first state) to a low state ST2 (e.g., second state).

The timing controller 170, upon receiving the first control signal SBC from the data driver 121, identifies that a lock fail of the clock signal has occurred in the data driver 121 (operation 1115). Once the timing controller 170 identifies the lock fail of the data driver 121, it transmits a clock training signal 1001 to the data driver 121 for lock recovery.

When transmitting the clock training signal 1001 to the data driver 121, the timing controller 170 may transmit a second control signal UPI_SYNC to the data driver 121. For example, the second control signal UPI_SYNC may be a clock signal, and the timing controller 170 may transition the second control signal UPI_SYNC from the high state ST1 to the low state ST2.

When lock of the clock signal is completed, the data driver 121 may transition the first control signal SBC from the low state ST2 to the high state ST1 (operation 1116). Once the matching for the clock training signal 1001 received from the timing controller 170 is completed, the data driver 121 determines that the lock of the clock signal has been completed and transitions the first control signal SBC from the low state ST2 to the high state ST1.

The timing controller 170 may identify that the lock of the clock signal in the data driver 121 has been completed based on the transition of the first control signal SBC from the low state ST2 to the high state ST1 (operation 1117). After identifying that the lock of the clock signal is completed, the timing controller 170 transitions the second control signal UPI_SYNC from the low state ST2 to the high state ST1, to complete transmission of the clock training signal 1001.

The timing controller 170 may transmit a frame protocol 1002 to the data driver 121 (operation 1118). The frame protocol 1002 includes setup data that the timing controller 170 transmits to the data driver 121 at the beginning of every frame. The timing controller 170 retransmits the frame protocol 1002 in case the frame protocol 1002 has been damaged as a lock fail has occurred in the data driver 121.

The timing controller 170 resumes transmission of image data and transmits an identification signal Fsync to the data driver 121 to identify the transmission time point of the first image data (e.g., odd data) (operation 1119). When resuming the transmission of image data, the timing controller 170 first outputs first image data (e.g., odd data) among the first image data (e.g., odd data) and the second image data (e.g., even data).

When the timing controller 170 resumes transmission of the image data, the data driver 121 divides the received image data into the first image data (e.g., odd data) and the second image data (e.g., even data) based on the identification signal Fsync. The data driver 121 resumes transmission of image data to the switching unit 600, and first outputs first image data (e.g., odd data) from among the first image data (e.g., odd data) and the second image data (e.g., even data), and then outputs the first image data (e.g., odd data) and the second image data (e.g., even data) alternately (e.g., alternates between outputting the second image data and the first image data).

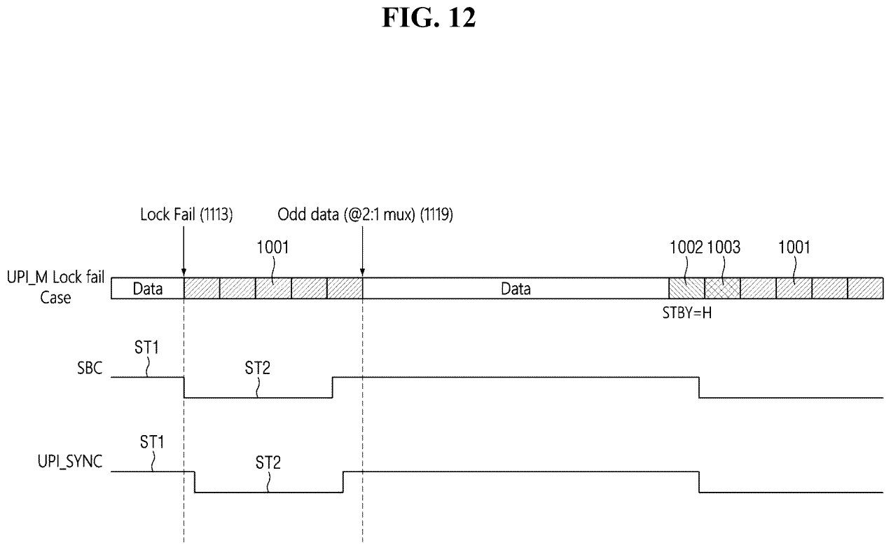

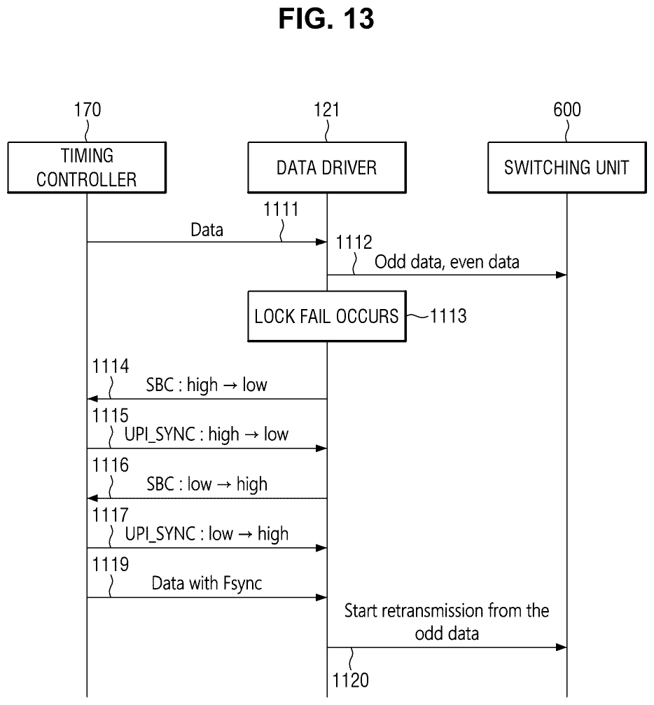

FIG. 12 is a diagram illustrating an example in which a timing controller according to some embodiments of the present disclosure does not output a frame protocol 1002 after performing lock recovery. FIG. 13 is a signal diagram illustrating the operation of a display device 10 according to some embodiments of the present disclosure.

The embodiments of FIGS. 12 and 13 are different from the embodiments of FIGS. 10 and 11 in that the timing controller 170 does not transmit a frame protocol 1002 to the data driver 121 after it performs lock recovery. For example, once transmission of a clock training signal 1001 is completed, the timing controller 170 may transmit first image data (e.g., odd data) along with an identification signal Fsync.

The embodiments of FIGS. 12 and 13 are substantially identical to the embodiments of FIGS. 10 and 11 except for the above difference; and, therefore, the redundant descriptions will be omitted.

According to embodiments of the present disclosure, it is possible to reduce the number of data drivers in a display device. In addition, it is possible to prevent or substantially reduce display defects by allowing the data driver to accurately distinguish the type of image data input from the timing controller.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” “comprising,” “has,” “have,” and “having,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, “in contact with”, “in direct contact with”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art. Further, if the term “substantially” is used in combination with a feature that could be expressed using a numeric value, the term “substantially” denotes a range of +/−5% of the value centered on the value. Furthermore, a specific quantity or range recited in this written description or the claims may also encompass the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

The display device and/or any other relevant devices or components according to embodiments of the present invention described herein may be implemented utilizing any suitable hardware, firmware (e.g., an application-specific integrated circuit), software, or a suitable combination of software, firmware, and hardware. For example, the various components of the display device may be formed on one integrated circuit (IC) chip or on separate IC chips. Further, the various components of the display device may be implemented on a flexible printed circuit film, a tape carrier package (TCP), a printed circuit board (PCB), or formed on a same substrate. Further, the various components of the display device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A display device comprising:
a display panel;
a timing controller configured to output image data;
a data driver configured to receive the image data from the timing controller, to divide the received image data into first image data and second image data, and to alternately output the first image data and the second image data; and
a switching circuit configured to receive the first image data and the second image data from the data driver, to supply the first image data to sub-pixels of a first group in the display panel, and to supply the second image data to sub-pixels of a second group in the display panel,
wherein the timing controller is configured to:
identify that a lock fail of a clock signal has occurred in the data driver upon receiving a first control signal from the data driver while transmitting the image data for one frame; and
upon identifying the lock fail, to interrupt transmission of the image data and to transmit a clock training signal to the data driver to lock the clock signal, and to resume transmission of the image data when lock of the clock signal is completed, and to transmit to the data driver an identification signal for identifying a transmission time point of the first image data.

2. The display device of claim 1, wherein the sub-pixels of the first group are odd sub-pixels of a plurality of sub-pixels in the display panel that are arranged in odd columns, and
wherein the sub-pixels of the second group are even sub-pixels of the plurality of sub-pixels that are arranged in even columns.

3. The display device of claim 2, wherein the timing controller is configured to output the first image data when resuming transmission of the image data.

4. The display device of claim 3, wherein the timing controller, upon receiving the first control signal, is configured to transmit a second control signal for controlling training of the data driver and the clock training signal to the data driver.

5. The display device of claim 4, wherein the timing controller is configured to transmit a frame protocol to the data driver before outputting the first image data when resuming transmission of the image data, and
wherein the frame protocol is a setup signal.

6. The display device of claim 3, wherein the data driver is configured to divide the received image data into the first image data and the second image data based on the identification signal when the timing controller resumes transmission of the image data, and to output the first image data and the second image data alternately.

7. The display device of claim 2, wherein the switching circuit is configured to receive the first image data and the second image data from the data driver, and
wherein the switching circuit comprises a first switching circuit is configured to supply the first image data to the odd sub-pixels in response to a first switching signal output from the timing controller, and a second switching circuit is configured to supply the second image data to the even sub-pixels in response to a second switching signal output from the timing controller.

8. The display device of claim 7, wherein the switching circuit is in a non-display area of the display panel.

9. The display device of claim 8, wherein the switching circuit comprises a thin-film transistor.

10. The display device of claim 8, wherein the timing controller is configured to synchronize a time point of outputting the first switching signal with a time point of outputting the identification signal when resuming transmission of the image data.

11. The display device of claim 7, wherein the switching circuit is in the data driver.

12. The display device of claim 11, wherein the timing controller is configured to synchronize a time point of outputting the first switching signal with a time point of outputting the identification signal when resuming transmission of the image data.

13. A method for driving a display device, the method comprising:
outputting, by a timing controller, image data;
receiving, by a data driver, the image data from the timing controller to divide the received image data into first image data and second image data;
alternately outputting, by the data driver, the first image data and the second image data;
receiving, by a switching circuit, the first image data and the second image data from the data driver, to supply the first image data to sub-pixels of a first group in a display panel, and to supply the second image data to sub-pixels of a second group in the panel;
identifying, by the timing controller, that a lock fail of a clock signal has occurred in the data driver upon receiving a first control signal from the data driver while transmitting the image data for one frame;
upon identifying the lock fail by the timing controller, interrupting transmission of the image data and transmitting a clock training signal to the data driver to lock the clock signal; and
resuming, by the timing controller, transmission of the image data when lock of the clock signal is completed, and transmitting to the data driver an identification signal for identifying a transmission time point of the first image data.

14. The method of claim 13, wherein the sub-pixels of the first group are odd sub-pixels of a plurality of sub-pixels that are arranged in odd columns in the display panel, and
wherein the sub-pixels of the second group are even sub-pixels of the plurality of sub-pixels that are arranged in even columns.

15. The method of claim 14, further comprising:
outputting, by the timing controller, the first image data when resuming transmission of the image data.

16. The method of claim 15, further comprising:
upon receiving the first control signal, transmitting, by the timing controller, a second control signal for controlling training of the data driver and the clock training signal to the data driver.

17. The method of claim 16, further comprising:
transmitting, by the timing controller, a frame protocol to the data driver before outputting the first image data when resuming transmission of the image data,
wherein the frame protocol is a setup signal.

18. The method of claim 17, further comprising:
dividing, by the data driver, the received image data into the first image data and the second image data based on the identification signal when the timing controller resumes the transmission of the image data.

19. The method of claim 18, further comprising:
supplying, by a first switching circuit of the switching circuit, the first image data to the odd sub-pixels in response to a first switching signal output from the timing controller; and
supplying, by a second switching circuit of the switching circuit, the second image data to the even sub-pixels in response to a second switching signal output from the timing controller.

20. The method of claim 19, further comprising:
synchronizing, by the timing controller, a time point of outputting the first switching signal with a time point of outputting the identification signal when resuming transmission of the image data.
